(19) United States
(12) Patent Application Publication
(10) Pub. No.: US 2011/0164652 A1
(43) Pub. Date: Jul. 7, 2011

(54) Differential Thermoelectric Cooler Calorimeter

(76) Inventors: Lee A. ReFalo, Aiken, SC (US); George E. Weeks, North Augusta, SC (US)

(21) Appl. No.: 12/655,660

(22) Filed: Jan. 5, 2010

(51) Int. Cl. G01K 17/00; F25B 21/02

(52) U.S. Cl. 374/31; 62/3.6; 374/E17.001

(57) ABSTRACT

A calorimeter for use in measuring a sample is provided. The calorimeter may include a sample chamber for housing the sample therein. A separate reference chamber may not be present in the calorimeter. The calorimeter may also have a sample thermoelectric cooler in which heat from the sample chamber is transferred to the sample thermoelectric cooler. A reference thermoelectric cooler for use in detecting thermal noise may also be present, and outputs from the sample thermoelectric cooler and the reference thermoelectric cooler may be used in a control equation to determine the heat output of the sample.

### STATEMENT AS TO RIGHTS TO INVENTIONS MADE UNDER FEDERALLY SPONSORED RESEARCH AND DEVELOPMENT

This invention was made with Government support under Contract No. DE-AC09-96SR18500 awarded by the United States Department of Energy. The Government has certain rights in the invention.

### FIELD OF THE INVENTION

This invention is directed towards a differential thermoelectric cooler calorimeter that is designed to measure thermal properties of a substance. More particularly, the present application involves a differential thermoelectric cooler calorimeter that includes a controlled heat removal path and that lacks a separate reference chamber for use in measuring substances such as nuclear materials.

### BACKGROUND

The use of a differential thermoelectric cooler calorimeter is known for use in acquiring information relating to a chemical reaction, change of state, or solution formation of a substance. In certain applications, a differential thermoelectric cooler calorimeter may be used to measure materials, such as nuclear materials, to identify the amount of heat output therefrom. One such known differential thermoelectric cooler calorimeter 10 is illustrated in FIG. 1 and includes a reference chamber 12 and a sample chamber 14. A vacuum chamber 16 is located between the two chambers 12 and 14, and the reference chamber 12 and the sample chamber 14 are thermally isolated from one another.

Reference thermoelectric coolers 18 measure the reference chamber 12, and sample thermoelectric coolers 20 can measure the sample chamber 14. An insulation layer 22 can surround both the reference chamber 12 and sample chamber 14 to prevent heat from exiting or entering the chambers 12 and 14 from the outside to prevent measurement errors. A cooling circuit 24 can also surround the insulation layer 22 to further maintain a constant temperature on the system to seek to reduce thermal noise. A sample 26 that emits heat may be located within the sample chamber 14.

The reference chamber 12 is present in order to account for exogenous heat flow (noise). The sample thermoelectric coolers 20 provide sample voltages, and the reference thermoelectric coolers 18 likewise provide reference voltages. The heat measurement of the sample 26 can be obtained from subtracting the reference voltages from the sample voltages. A calibration may then be made to convert this result into a watts/volt value to result in the heat generation value of the sample 26. Although capable of obtaining information relative to sample 26, the differential thermoelectric cooler calorimeter 10 requires a large amount of available space for making accurate measurements. Further, external heat flow may be present into one of the chambers 12 or 14 but not the other chamber 12 or 14. Accordingly, there remains room for variation and improvement within the art.

### BRIEF DESCRIPTION OF THE DRAWINGS

A fully enabling disclosure of the present invention, including the best mode thereof to one of ordinary skill in the art, is set forth more particularly in the remainder of the specification, including reference to the accompanying drawings.

FIG. 1 is a front elevation view of a known differential thermoelectric cooler calorimeter.

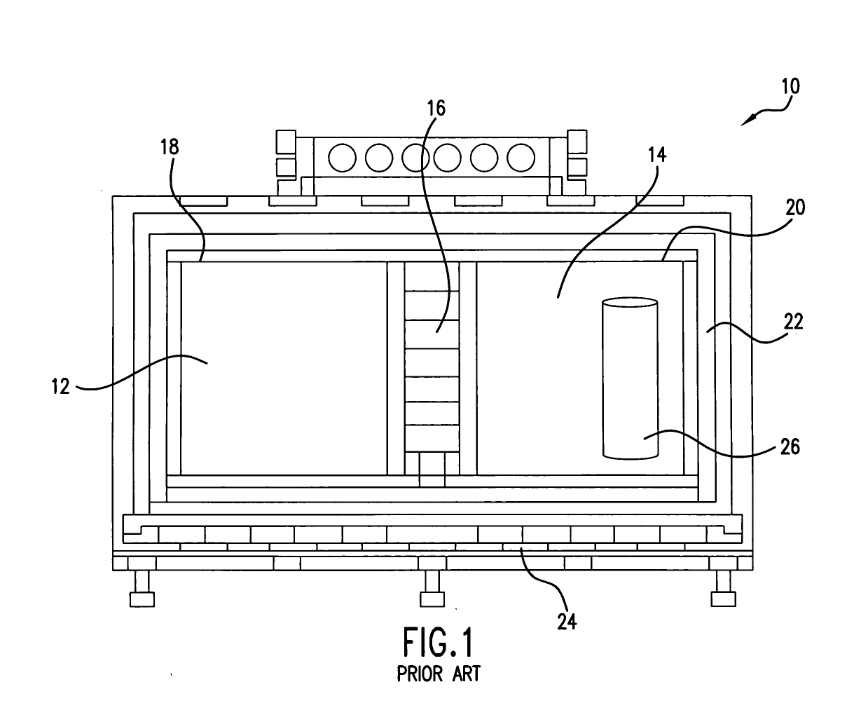

FIG. 2 is a front elevation view of a differential thermoelectric cooler calorimeter in accordance with one exemplary embodiment.

### DETAILED DESCRIPTION OF REPRESENTATIVE EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to 7 also includes a limit of up to 5, up to 3, and up to 4.5.

The present invention provides for a differential thermoelectric cooler calorimeter 10 capable of measuring the heat output of a sample 26. The calorimeter 10 can be arranged so that a separate reference chamber 12 is not present in the design. Elimination of the reference chamber 12 may allow for a space savings to be realized in applications in which space is at a premium. For example, measurements of samples 26 in a nuclear environment may be conducted in a smaller space with a calorimeter 10 that lacks a reference chamber 12 apart from a sample chamber 14.

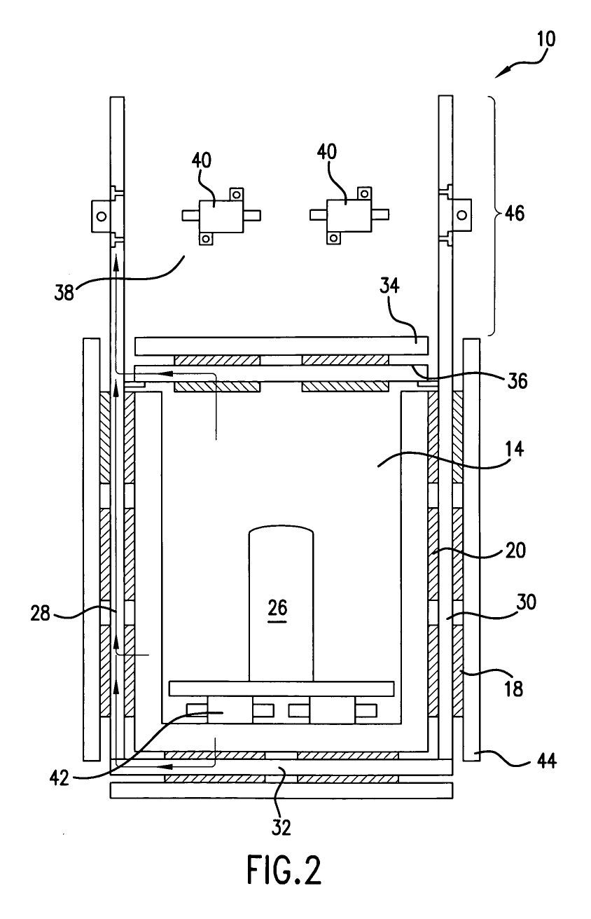

A calorimeter 10 in accordance with one exemplary embodiment is illustrated in FIG. 2. The calorimeter 10 includes a sample chamber 14 into which a sample 26 may be located. The calorimeter 10 includes a plurality of sample thermoelectric coolers 20 that are adjacent the sample chamber 14. The sample thermoelectric coolers 20 can directly face the sample chamber 14 and in effect function to define one or more walls of the sample chamber 14. Alternatively, a container that at least partially defines the sample chamber 14 may be located between the sample thermoelectric coolers 20 and the sample chamber 14. As such, the sample thermoelectric coolers 20 need not directly face the sample chamber 14 in certain embodiments. Also, although shown as including a plurality of sample thermoelectric coolers 20, a single sample thermoelectric cooler 20 may be used in other embodiments. In yet further embodiments, any number of coolers 20 can be employed. For example, from 5-10, from 10-15, from 15-30, or from 30-60 sample thermoelectric coolers 20 may be included in the calorimeter 10 in other exemplary embodiments.

The sample thermoelectric coolers 20 react differently upon an amount of heat to which they are subjected. This difference may function to cause a proportional voltage output to be generated by the sample thermoelectric coolers 20. As such, the sample thermoelectric coolers 20 may generate a voltage output based upon the temperature applied thereto. It is to be understood, however, that the sample thermoelectric coolers 20 may generate an output in a different manner from that previously discussed upon being subjected to an amount of, or change in, heat.

The sample 26 may generate heat. For example, the sample 26 may be radioactive or may include a chemical reaction. Heat generated by sample 26 can be transferred into the sample thermoelectric coolers 20. A sample plate 30 may surround the sample thermoelectric coolers 20 and the heat transferred to the sample thermoelectric coolers 20 may then be subsequently transferred to the sample plate 30. The sample plate 30 may be a single piece or may be made of multiple pieces. Further, the sample plate 30 may be variously shaped. For example, the sample plate 30 may be cylindrical, square, octagonal, or rectangular in shape in accordance with certain embodiments. As shown in FIG. 2, the sample plate 30 is cylindrical in shape, and the sample thermoelectric coolers 20 are directly attached to a side of the sample plate 30. As such, the sample plate 30 is located adjacent the sides of the sample chamber 14 with the sample thermoelectric coolers 20 disposed therebetween.

A plurality of reference thermoelectric coolers 18 may be included in the calorimeter 10 and may be located on the side of the sample plate 30 opposite the side to which the sample thermoelectric coolers 20 are attached. Any number of reference thermoelectric coolers 18 may be included. For example, from 1 to 10, from 10 to 20, or up to 50 reference thermoelectric coolers 18 may be included in certain embodiments. In some embodiments, the same number of reference thermoelectric coolers 18 and sample thermoelectric coolers 20 may be present. In other embodiments, greater or fewer coolers 18 than coolers 20 may be present. The reference thermoelectric coolers 18 may be constructed in an identical manner as the sample thermoelectric coolers 20 discussed above and a repeat of this information is not necessary. The reference thermoelectric coolers 18 may be present in the same number and located immediately opposite the sample thermoelectric coolers 20 with the sample plate 30 located between the coolers 18 and 20.

The calorimeter 10 may also include a bottom plate 32 that is located adjacent the bottom of the sample chamber 14. The bottom plate 32 may be permanently attached to the sample plate 30 or may be capable of being removed from the sample plate 30. In certain embodiments, the bottom plate 32 may be integrally formed with the sample plate 30 and not a separate component therefrom. One or more sample thermoelectric coolers 20 can be attached to the top of the bottom plate 32 that faces towards the sample chamber 14. One or more reference thermoelectric coolers 18 may be attached to the opposite, bottom side of the bottom plate 32. Heat from the sample chamber 14 may be transferred through the sample thermoelectric coolers 20 and into the bottom plate 32. The bottom plate 32 can be in contact with the sample plate 30 so that this heat is conducted into the sample plate 30.

A plug 34 may be located adjacent the top of the sample chamber 14. The plug 34 may be removably attached to the sample plate 30 so that the plug 34 can be removed in order to insert or remove the sample 26 into or out of the sample chamber 14. The plug 34 may include a center plate 36 that may be in contact with the sample plate 30 so that heat can be conducted from the center plate 36 to the sample plate 30. However, it is to be understood that the center plate 36 need not contact the sample plate 30 in other arrangements. One or more sample thermoelectric coolers 20 may be attached to the center plate 36 and can face the sample chamber 14. Likewise, one or more reference thermoelectric coolers 18 may be located on the side of the center plate 36 opposite from the side to which the sample thermoelectric coolers 20 are attached.

The calorimeter may further include an upper section 38 that is located above the sample chamber 14. In some arrangements, the plug 34 may be located between the sample chamber 14 and the upper section 38 so that the plug 34 has a side that defines the top of the sample chamber 14 and an opposite side that defines the bottom of the upper section 38. The sample plate 30 may extend into and at least partially define the upper section 38. In this regard, a portion 46 of the sample plate 30 can define the sides of the upper section 38. Further, the portion 46 itself may likewise in fact be a part of the upper section 38. The upper section 38 may be open at the top so that the top of the portion 46 defines the upper most point of the upper section 38. In other arrangements a cap (not shown) may cover the top of the upper section 38 and may or may not function as insulation.

The calorimeter 10 can also include one or more upper section heaters 40 that function to provide heat to the upper section 38. In some arrangements, the upper section heaters 40 may be resistive heaters and can generate heat by the passage of an electrical current therethrough. Also, one or more sample chamber heaters 42 may be located in or proximate to the sample chamber 14 for the purpose of supplying heat to the sample chamber 14. In a similar fashion, the sample chamber heaters 42 can be resistive heaters.

The differential thermoelectric cooler calorimeter 10 may be provided so that a separate reference chamber 12 is not present. In this regard, even if a reference chamber 12 could somehow be found to exist, such a reference chamber 12 surrounds the sample chamber 14. This may cause the reference chamber 12 and the sample chamber 14 to share some of the same space. In certain instances, any such reference chamber 12 would surround the top, bottom, and sides of the sample chamber 14. As such, the reference thermoelectric coolers 18 may define a space, that may be cylindrical, square, or triangular in shape, that completely encloses, covers, surrounds, or includes all of the sample thermoelectric coolers 20.

Operation of the measuring technique of the calorimeter 10 involves placement of the sample 26 within the sample chamber 14 and the application of heat to the sample chamber 14 by the sample chamber heater 42. Heat from the sample chamber 14 may be transferred into the sample thermoelectric coolers 20 and then into the sample plate 30, bottom plate 32, and center plate 36. The sample thermoelectric coolers 20 will generate a voltage response based upon the amount of heat transferred therein. A heat removal path 28 may be defined by the sample thermoelectric coolers 20 and the sample plate 30 so that the heat is transferred from the sample chamber 14 to the upper section 38. In certain arrangements, the bottom plate 32 and the center plate 36 may also define a portion of the heat removal path 28 so that heat transferred into these portions can be transferred to the upper section 38. The upper section 38 may be maintained at a constant temperature. In this regard, the amount of heat generated by the upper section heaters 40 can be regulated so that the upper section 38 maintains a constant temperature. The interior cavity of the upper section 38 or the portion 46 of the sample plate 30 in the upper section 38 may be monitored and maintained at a constant temperature. Heat transfer from the heat removal path 28 may act to increase the temperature of the upper section 38 thus resulting in an appropriate response from the upper section heaters 40. In yet other exemplary embodiments, the center plate 36 of the plug 34 may be a part of the upper section 38. In this regard, the entire plug 34 or only portions of the plug 34 may be part of the upper section 38.

It may be the case that all of the heat from the sample chamber 14 does not flow through the heat removal path 28. For example, some of the heat may flow through the sample plate 30, bottom plate 32, or center plate 36 to the sides opposite those that face towards the sample chamber 14. This heat will be transferred to the reference thermoelectric coolers 18 and the reference thermoelectric coolers 18 will generate a voltage in response to the amount of heat detected. Additionally or alternatively, heat may flow into the reference thermoelectric coolers 18 from outside of the system. A reference plate 44 may be located on the exterior of the reference thermoelectric coolers 18 so that the reference thermoelectric coolers 18 are located between the reference plate 44 and the sample thermoelectric coolers 20. The reference plate 44 may be used to synchronize the sample thermoelectric coolers 20 with the reference thermoelectric coolers 18. The reference thermoelectric coolers 18 may thus be used to account for “thermal noise” in the system and can detect heat being transferred from either the reference plate 44, the sample plate 30, the bottom plate 32, or the center plate 36.

The heat removal path 28 may function to transfer heat into a portion outside of the sample chamber 14. As shown, heat may be transferred to the upper section 38. The temperature at the upper section 38 may be kept constant which may allow for a control equation to be established that allows for measurements of the sample 26 without the need of a separate reference chamber 12.

The system is run according to a control equation in which the input to the upper section heater 40 and the sample chamber heater 42 is varied based upon the control equation. As stated, the control equation may be arranged so that the upper section 38 is maintained at a constant temperature. The control equation may be established by making several independent measurements of the various reference and sample thermoelectric coolers 18 and 20. The independent measurements may be made of the sample thermoelectric coolers 20 on the sides of the sample chamber 14, the reference thermoelectric coolers 18 located exterior to the sides of the sample chamber 14, the reference and sample thermoelectric coolers 18 and 20 at the bottom plate 32, and the reference and sample thermoelectric coolers 18 and 20 located at the center plate 36. A regression analysis may be completed to develop a characteristic equation for servo control.

Once a control equation is established for the calorimeter 10, one or more measurements may be taken with the sample chamber 14 empty. In this regard, the sample 26 is not present in the sample chamber 14. The measurements are conducted in order to determine the amount of power necessary to keep the control equation constant. For example, the calorimeter 10 can be run and it may be found that 0.75 watts are necessary to keep the control equation constant without the presence of a sample 26 in the sample chamber 14. Next, a sample 26 can be located within the sample chamber 14 and the process may be rerun. The amount of power necessary to keep the control equation constant with the presence of the sample 26 may then be determined. For instance, it may be the case that it takes 0.50 watts to keep the control equation constant when the sample 26 is present. The sample 26 may then be found to contribute 0.25 watts (0.75 watts-0.50 watts). The sample 26 may then be said to have a heat output of 0.25 watts.

The calorimeter 10 may be run a single time without the presence of the sample 26, and then multiple samples 26 may be inserted into the sample chamber 14 and servo control can be performed to measure the heat output of the samples 26. Alternatively, the measurements may be performed so that a run of the calorimeter 10 without the sample 26 is conducted every time before a new sample 26 is introduced into the sample chamber 14.

In certain exemplary embodiments, the control equation may include the subtraction of the output of the reference thermoelectric coolers 18 from the output of the sample thermoelectric coolers 20 so that the thermal noise present in the system is eliminated. However, other exemplary embodiments include control equations that do not include this calculation or include other additional calculations. The output from the reference thermoelectric coolers 18 and the sample thermoelectric coolers 20 may be in volts, and a calibration may be performed in order to transform the voltage outputs into watts/volt outputs. The amount of heat output by the sample 26 may be expressed in units of watts. However, it is to be understood that other arrangements are possible in which the heat output is expressed in units other than watts.

In accordance with other versions of the calorimeter, a cooling circuit 24 or insulation 22 may surround components such as the upper section 38, reference thermoelectric coolers 18, or reference plate 44 so as to reduce thermal noise during the measurements.

### EXPERIMENTS CARRIED OUT IN ACCORDANCE WITH EXEMPLARY EMBODIMENT

Measurements were conducted with a calorimeter 10 as provided with respect to the exemplary embodiment illustrated in FIG. 2. The calorimeter 10 was set up so that a sample 26 was not present in the sample chamber 14. The calorimeter 10 was run so that the control equation established for the calorimeter 10 was kept constant. The amount of power delivered by the sample chamber heaters 42 to keep the control equation constant was recorded on various days as set forth in Table 1 below.

TABLE 1

| | Power (watts) of |
|---|---|
| | sample chamber |
| Date | heaters 42 |
| May 1, 2008 | 1.0083 |
| May 2, 2008 | 1.0080 |
| May 4, 2008 | 1.0088 |
| May 6, 2008 | 1.0089 |
| May 9, 2008 | 1.0082 |
| May 10, 2008 | 1.0081 |
| May 12, 2008 | 1.0086 |
| May 13, 2008 | 1.0084 |
| May 14, 2008 | 1.0090 |
| May 15, 2008 | 1.0082 |

Samples 26 were then inserted into the sample chamber 14 and measurements of the calorimeter 10 were rerun so that the control equation was again satisfied. The following Table 2 represents data acquired through the use of a sample 26 that emitted approximately 0.14 watts of heat. The amount of power delivered by the sample chamber heaters 42 to keep the control equation constant was measured.

TABLE 2

| | Power (watts) of |
|---|---|
| | sample chamber |
| Date | heaters 42 |
| May 1, 2008 | 0.8622 |
| May 3, 2008 | 0.8622 |
| May 6, 2008 | 0.8631 |
| May 8, 2008 | 0.8622 |
| May 9, 2008 | 0.8612 |

The amount of heat generated by the sample 26 may then be measured upon subtracting the power needed to maintain the control equation with the sample 26 present from the amount of power needed to maintain the control equation with the sample 26 absent. For example, using the May 1, 2008 data values it is found that 1.0083 watts that were needed without the sample 26 minus 0.8622 watts that were needed with the sample 26 results in the sample 26 providing 0.1461 watts.

Additional measurements were run with a sample 26 that generates approximately 0.30 watts of heat. The results of these measurements are provided in Table 3 below.

TABLE 3

| | Power (watts) of |
|---|---|
| | sample chamber |
| Date | heaters 42 |
| May 13, 2008 | 0.7062 |
| May 14, 2008 | 0.7047 |
| May 15, 2008 | 0.7048 |
| May 16, 2008 | 0.7056 |
| May 17, 2008 | 0.7060 |

The amount of heat generated by the sample 26 may again be determined upon subtracting the power needed to maintain the control equation with the sample 26 present from the power needed with the sample 26 absent. Selection of the May 13, 2008 data from Tables 1 and 3 yields a heat output of 1.0084 watts with the sample 26 absent minus 0.7062 watts with the sample 26 present of 0.3022 watts.

The overall error of the system was found to be approximately 0.001 watts which was one sigma or 0.1% of the base servo controlled power. Other means for measuring the heat of the sample 26 may be performed. For example, instead of using the data from the same day, the average power output over the ten measured runs of the calorimeter 10 without the sample 26 may be obtained. Further, the average power output of the calorimeter 10 with the same sample 26 therein can be obtained and then this average value can be subtracted from the average power output value of the calorimeter 10 without the sample 26 to arrive at the heat output of the sample 26.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

1. A calorimeter for use in measuring a sample, comprising:
a sample chamber for housing the sample therein;
a plurality of sample thermoelectric coolers located adjacent the sample chamber, wherein heat from the sample chamber is transferred to the sample thermoelectric coolers;
a sample plate that at least partially defines a heat removal path, wherein the sample thermoelectric coolers are adjacent to one side of the sample plate; and
a plurality of reference thermoelectric coolers adjacent to the sample plate on a side of the sample plate opposite from the side to which the sample thermoelectric coolers are adjacent;
wherein outputs from the sample thermoelectric coolers and the reference thermoelectric coolers are used in measuring the sample.

2. The calorimeter as set forth in claim 1, further comprising:
a bottom plate adjacent to the bottom of the sample chamber, wherein at least one of the sample thermoelectric coolers is adjacent to the bottom of the sample chamber and the bottom plate, wherein the bottom plate is located between one of the reference thermoelectric coolers and one of the sample thermoelectric coolers that is adjacent to the bottom of the sample chamber and the bottom plate; and
a plug adjacent to the top of the sample chamber, wherein the plug has a center plate, wherein at least one of the sample thermoelectric coolers is adjacent to the top of the sample chamber and the center plate, wherein the center plate is located between one of the reference thermoelectric coolers and one of the sample thermoelectric coolers that is adjacent to the top of the sample chamber and the center plate.

3. The calorimeter as set forth in claim 2, wherein the heat removal path is defined by the sample thermoelectric coolers, the sample plate, the bottom plate, and the center plate such that heat from the sample chamber is transferred from the sample chamber through the heat removal path.

4. The calorimeter as set forth in claim 1, further comprising:
an upper section located adjacent the sample chamber and at least partially defined by the sample plate; and
an upper section resistor heater located at the upper section, wherein the upper section resistor heater supplies heat for the purpose of maintaining the upper section at a constant temperature.

5. The calorimeter as set forth in claim 1, further comprising a sample chamber resistor heater located at the sample chamber, wherein the sample chamber resistor heater supplies heat to the sample chamber for the purpose of maintaining a control equation for use in determining the heat output of the sample.

6. The calorimeter as set forth in claim 1, wherein the sample thermoelectric coolers surround the sides of the sample chamber, wherein the sample plate surrounds the sample thermoelectric coolers that surround the sides of the sample chamber, and wherein the reference thermoelectric coolers surround the portion of the sample plate that surrounds the sample thermoelectric coolers that surround the sides of the sample chamber.

7. The calorimeter as set forth in claim 1, further comprising a reference plate located adjacent to the reference thermoelectric coolers, wherein the reference thermoelectric coolers are located between the reference plate and the sample plate.

8. A calorimeter for use in measuring a sample, comprising:
a sample chamber for housing the sample therein, wherein the calorimeter does not have a separate reference chamber;
a sample thermoelectric cooler, wherein heat from the sample chamber is transferred to the sample thermoelectric cooler;
a reference thermoelectric cooler for use in detecting thermal noise;
wherein outputs from the sample thermoelectric cooler and the reference thermoelectric cooler are used in a control equation to determine the heat output of the sample.

9. The calorimeter as set forth in claim 8, further comprising a sample plate that at least partially defines an upper section, wherein heat from the sample chamber is transferred through the sample thermoelectric cooler to the sample plate.

10. The calorimeter as set forth in claim 9, further comprising:
a sample chamber resister heater that supplies heat to the sample chamber;
an upper section resistor heater that supplies heat to the upper section, wherein heat output by the sample chamber resister heater and the upper section resistor heater is controlled in order to maintain the control equation to determine the heat output of the sample.

11. The calorimeter as set forth in claim 10, wherein the upper section resistor heater functions to maintain the upper section at a constant temperature, wherein heat from the sample chamber is transferred through the sample thermoelectric cooler to the sample plate and into the portion of the sample plate that at least partially defines the upper section.

12. The calorimeter as set forth in claim 11, further comprising a plug that at least partially defines the upper section and at least partially defines the sample chamber, wherein the plug is capable of being removed in order to allow access into the sample chamber for the removal or insertion of the sample from or into the sample chamber.

13. The calorimeter as set forth in claim 8, wherein a plurality of the sample thermoelectric coolers are present, and wherein a plurality of the reference thermoelectric coolers are present, and further comprising:
a bottom plate adjacent to the bottom of the sample chamber, wherein at least one of the sample thermoelectric coolers is adjacent to the bottom of the sample chamber and the bottom plate, wherein the bottom plate is located between one of the reference thermoelectric coolers and one of the sample thermoelectric coolers that is adjacent to the bottom of the sample chamber and the bottom plate; and
a plug adjacent to the top of the sample chamber, wherein the plug has a center plate, wherein at least one of the sample thermoelectric coolers is adjacent to the top of the sample chamber and the center plate, wherein the center plate is located between one of the reference thermoelectric coolers and one of the sample thermoelectric coolers that is adjacent to the top of the sample chamber and the center plate.

14. The calorimeter as set forth in claim 8, wherein a plurality of the sample thermoelectric coolers are present, and wherein a plurality of the reference thermoelectric coolers are present, wherein the sample thermoelectric coolers surround the sides of the sample chamber, and wherein the reference thermoelectric coolers surround the sample thermoelectric coolers.

15. A calorimeter for use in measuring a sample, comprising:
a sample chamber for housing the sample therein;
a sample chamber heater for heating the sample chamber;
a sample thermoelectric cooler, wherein heat from the sample chamber is transferred to the sample thermoelectric cooler;
a sample plate, wherein heat from the sample thermoelectric cooler is transferred to the sample plate, wherein the sample plate at least partially defines an upper section;
a reference thermoelectric cooler;
an upper section heater for heating the upper section;
wherein the sample thermoelectric cooler and the sample plate define a heat flow path in which heat from the sample chamber is transferred to the upper section through the heat flow path;
wherein outputs from the sample thermoelectric cooler and the reference thermoelectric cooler are used in a control equation to determine the heat output of the sample.

16. The calorimeter as set forth in claim 15, wherein the upper section heater is used to maintain the upper section at a constant temperature, and wherein the amount of heat generated by the sample chamber heater is varied based upon the control equation for use in determining the heat output of the sample.

17. The calorimeter as set forth in claim 15, wherein the sample thermoelectric cooler directly faces the sample chamber and is attached to a side of the sample plate, wherein the reference thermoelectric cooler is attached to a side of the sample plate that is opposite to the side of the sample plate to which the sample thermoelectric cooler is attached.

18. The calorimeter as set forth in claim 17, wherein a plurality of the sample thermoelectric coolers are present, and wherein a plurality of the reference thermoelectric coolers are present, and further comprising:
a bottom plate that partially defines the sample chamber and is at the bottom of the sample chamber, wherein at least one of the sample thermoelectric coolers is attached to a side of the bottom plate, wherein at least one of the reference thermoelectric coolers is attached to the side of the bottom plate that is opposite to the side to which the sample thermoelectric cooler is attached; and
a plug that partially defines the sample chamber and is at the top of the sample chamber, wherein the plug has a center plate, wherein at least one of the sample thermoelectric coolers is attached to a side of the center plate, wherein at least one of the reference thermoelectric coolers is attached to a side of the center plate that is opposite to the side to which the sample thermoelectric cooler is attached;
wherein the bottom plate and the center plate are in thermal communication with the sample plate and define a portion of the heat flow path.

19. The calorimeter as set forth in claim 15, further comprising a reference plate attached to the reference thermoelectric cooler, wherein the reference thermoelectric cooler is attached to the sample plate such that the reference thermoelectric cooler is located between the sample plate and the reference thermoelectric cooler.

20. The calorimeter as set forth in claim 15, wherein the reference thermoelectric cooler produces an output that is used in the control equation to reduce thermal noise in the measurement of the heat output of the sample such that a reference chamber separate from the sample chamber is not present in the calorimeter.
